(19) United States
(12) Patent Application Publication
(10) Pub. No.: US 2024/0427884 A1
(43) Pub. Date: Dec. 26, 2024

(54) ROLLINGCACHE: USING RUNTIME BEHAVIOR TO DEFEND AGAINST CACHE SIDE CHANNEL ATTACKS

(71) Applicant: University of Rochester, Rochester, NY (US)

(72) Inventors: Divya Ojha, San Jose, CA (US); Sandhya Dwarkadas, Charlottesville, VA (US)

(73) Assignee: University of Rochester, Rochester, NY (US)

(21) Appl. No.: 18/431,444

(22) Filed: Feb. 2, 2024

Related U.S. Application Data
(60) Provisional application No. 63/442,778, filed on Feb. 2, 2023.

(51) Int. Cl. G06F 21/55

(52) U.S. Cl. CPC G06F 21/554; G06F 2221/034

(57) ABSTRACT

A RollingCache system and methodology defends against contention side-channel cache attacks by dynamically changing the set of addresses contending for cache sets. Unlike prior defenses, RollingCache system does not rely on address encryption, decryption, data relocation, or cache partitioning. One or more levels of indirection are used to implement dynamic mapping controlled by the whole-cache runtime behavior. The RollingCache system does not depend on having defined security domains and can defend against an attacker running on the same or another core.

### REFERENCE TO RELATED APPLICATIONS

This application claims priority to U.S. Provisional Patent Application Ser. No. 63/442,778 filed on Feb. 2, 2023, which is hereby incorporated by reference in its entirety.

### FEDERALLY SPONSORED RESEARCH AND DEVELOPMENT

This invention was made with Government Support under Contract CNS-1900803 awarded by the National Science Foundation. The Government has certain rights in the invention.

### FIELD OF THE INVENTION

The present invention relates to security of computer machines and associated information leak. The invention further relates to a cache system and methodology which defends against contention-based side channel contention attacks in cache sets without relying on address encryption, decryption, data relocation or cache portioning.

### BACKGROUND OF THE INVENTION

Modern computing architectures exploit properties of applications in order to improve performance including the use of memory hierarchies with caches. When these caches are shared across different executing entities, they potentially expose protected application information through side-channels. These side channels have been shown capable of leaking information across process boundaries, enclave boundaries, across privilege separations, and from speculative domains even in the presence of security measures such as process isolation and enclave separation. Cache side channels leveraging shared memory have been shown capable of extracting cryptographic keys, sensitive documents, and data even from cryptographically secured enclaves.

Contention side-channel attacks depend on having a shared cache between the attacker and the victim, and do not require the presence of shared memory. In a contention-based attack, the attacker tries to determine the victim's access pattern by identifying the cache set accessed by the victim. Since accesses to a set beyond the number of ways in a set, result in a conflict miss, an attacker can learn if a set was accessed by incurring a conflict miss due to the victim's accesses. The many-to-one mapping between the addresses and the set they map to in the cache results in a deterministic set of addresses that may cause conflict misses in any given cache set. Incurring a conflict miss on a set thus provides the knowledge of possible memory access patterns.

The hardware components shared across different processes can be used by one process to leak information from another. A wide range of architectures are vulnerable to cache side channels, including x86 (a family of complex instruction set computer (CISC) instruction set architectures initially developed by Intel Corporation based on the Intel 8086 microprocessor), ARM (or Advanced RISC Machines, is family of reduced instruction set computer (RISC) architectures), AMD, to name a few. Moreover, they and are a threat to a wide variety of computing domains, ranging from cloud computing, secure enclaves, to end user device. An attacker process can run on a different core or the same core as the victim. These attacks find applicability in leaking data across virtual machines, from secure enclaves and have been used to steal cryptographic keys from different protocols like Advanced Encryption Standard (AES), Data Encryption Standard (DES), and Rivest-Shamir-Adleman (RSA).

Vulnerabilities in cache and cache-like structures result from contention and reuse. While reusing another process's data requires shared memory, contention in the shared hardware resource can leak information even in the absence of shared memory. Contention attacks exploit the mapping between the memory address and the cache set. This predetermined mapping is required for quickly indexing into the correct set for data lookup but leaves the attacker with the group of addresses to guess from, for determining the victim's access pattern.

Eliminating cache side channels is challenging due to the performance trade-off typically involved in the defense. The strict timing requirements of the solution mostly rule out the possibilities of software intervention on every access. A compiler-based solution can transform software to make its control flow or data flow independent of any secret but result in undesirable access latency. Hardware solutions for process specific caching either using partitioning or locking process specific cache lines are typically unable to provide shared memory access to a large number of processes. Most solutions mitigate one or the other type of attack and are not comprehensive.

Prior work on defense against contention attacks hide the mapping between the addresses and their location in the cache by using encryption. Randomizing caches either use a lookup table to cache data at different locations for different security domains or use domain-specific encryption of address lines. Encryption and decryption of the address line can take extra cycles per access. Further, static encryption is susceptible to the rapidly advancing attacks, as a set of encrypted addresses can still be constructed to launch the same attack. While encryption keys can be changed frequently to prevent the discovery of eviction sets, doing so at a rate sufficient to deter the attack can result in significant power and performance impact, as it is accompanied by relocating the existing data in cache. Another common shortfall with existing defense techniques is that they require identified security domains for the defense to be effective.

Thus, the design and development of methods for protecting computing architecture vulnerability to contention side-channel attacks remains an important requirement for secure and reliable computing.

### SUMMARY OF THE INVENTION

Disclosed are exemplary embodiments of systems for defending against contention side-channel cache attacks, comprising one or a plurality of processors; at least one cache in communication with at least one of said processors; a system cache controller; an indirection pointer table that assigns addresses to one or more cache sets; a freelist of pointers (pointers to a collection of available or “free” cache sets) corresponding to available cache sets; and a pointer table engine for updating said indirection pointer table using said freelist of pointers and pointer indirection.

Embodiments may also include an indirection pointer table is further comprised of hardware pointers. Embodiments may also include a freelist is comprised of hardware pointers. Embodiments may also include an indirection pointer table and freelist comprises a microcode unit, and the microcode unit may further comprise said pointer table engine. Embodiments may also include a system cache controller further comprising said pointer table engine. Embodiments may also include a pointer table engine for updating said indirection pointer table uses one level of pointer indirection. Embodiments may also include a pointer table engine for updating said indirection pointer table that uses at least one level of pointer indirection.

Also disclosed are embodiments of a processor in communication with at least one cache and a cache controller, comprising circuitry configured to: receive an address, assign said address to a cache set using an indirection pointer table that assigns addresses to one or more cache sets using on a freelist of pointers corresponding to available cache sets, and update said indirection pointer table in the event of a cache miss by a pointer table engine using said freelist of available pointers and at least one level of pointer indirection.

Embodiments may also include circuitry comprising a microcode unit. Embodiments may also include an indirection pointer table that is further comprised of hardware pointers. Embodiments may also include a freelist is comprised of hardware pointers. Embodiments may also include a system cache controller further comprising instructions that implement the pointer table engine. Embodiments may also include a pointer table engine for updating an indirection pointer table that uses one level of pointer indirection. Embodiments may also include a pointer table engine for updating an indirection pointer table uses at least one level of pointer indirection.

Also disclosed is a method for defending against contention side-channel cache attacks in a system including a processor having at least one cache and a system cache controller, the method comprising:

initializing a pointer table engine and executing the pointer table engine to initialize the indirection pointer table and freelist; responding to the receipt of a cache request from the system cache controller: (a) responding to the determination by the pointer table engine that the cache request does not correspond to a cache miss, execute cache request; (b) responding to the determination by the pointer table engine that the cache request does correspond to a cache miss: replace pointer assignment in cache set associated with the existing pointer if replacement is available, and respond to the cache request based on pointer reassignment; otherwise, responding to the determination that a replacement is not available, select a cache set from the freelist, update indirection pointer table, and respond to the cache request using updated indirection pointer table.

Embodiments of the method may also include initializing an indirection pointer table further comprising randomly initializing the pointers of the indirection pointer table. Embodiments of the method may also include initializing a freelist further comprising randomly initializing the pointers of the freelist. Embodiments of the method may also include a pointer table engine for updating said indirection pointer table that uses at least one level of pointer indirection.

### BRIEF DESCRIPTION OF THE DRAWINGS

The features of the application can be better understood with reference to the drawings described below, and the claims. The drawings are not necessarily to scale, emphasis instead generally being placed upon illustrating the principles described herein. In the drawings, like numerals are used to indicate like parts throughout the various views.

FIG. 1A illustrates a computing architecture comprising a single processor core, a system cache controller and a shared cache in accordance with one or more illustrative embodiments of the present invention.

FIG. 1B illustrates a computing architecture comprising multiple executing entities hosted on separate computing processors in communication with a processor with a single core serviced by a system cache controller and a shared cache in accordance with one or more illustrative embodiments of the present invention.

FIG. 1C illustrates a computing architecture comprising multiple executing entities in communication with a multicore processor serviced by a system cache controller, levels of exclusive caches and a shared last level cache in accordance with one or more illustrative embodiments of the present invention.

FIG. 2 illustrates the shared cache configuration in a contention side-channel attack in accordance with one or more illustrative embodiments of the present invention.

FIG. 3 illustrates the steps in a contention side-channel attack upon a shared cache in accordance with one or more illustrative embodiments of the present invention.

FIG. 4 illustrates the elements of a RollingCache configuration for the minimization of contention side-channel attacks on a shared cache in accordance with one or more illustrative embodiments of the present invention.

FIG. 5A illustrates the use of pointer indirection facilitating cache set allocation for a two-way cache at an initial time in accordance with one or more illustrative embodiments of the present invention.

FIG. 5B illustrates the use of pointer indirection facilitating cache set allocation for a two-way cache after a first time interval step in accordance with one or more illustrative embodiments of the present invention.

FIG. 5C illustrates the use of pointer indirection facilitating cache set allocation for a two-way cache after a second time interval step in accordance with one or more illustrative embodiments of the present invention.

FIG. 5D illustrates the use of pointer indirection facilitating cache set allocation for a two-way cache after a third time interval step in accordance with one or more illustrative embodiments of the present invention.

FIG. 5E illustrates the use of pointer indirection facilitating cache set allocation for a two-way cache after a fourth time interval step in accordance with one or more illustrative embodiments of the present invention.

FIG. 5F illustrates the use of pointer indirection facilitating cache set allocation for a two-way cache after a fifth time interval step in accordance with one or more illustrative embodiments of the present invention.

FIG. 6A illustrates a state in a sequence of pointer updates facilitating cache set allocation occurring at an initial time in accordance with one or more illustrative embodiments of the present invention.

FIG. 6B illustrates a state in a sequence of pointer updates facilitating cache set allocation occurring after a first interval time step in accordance with one or more illustrative embodiments of the present invention.

FIG. 6C illustrates a state in a sequence of pointer updates facilitating cache set allocation occurring after a second time interval step in accordance with one or more illustrative embodiments of the present invention.

FIG. 6D illustrates a state in a sequence of pointer updates facilitating cache set allocation occurring after a third time interval step in accordance with one or more illustrative embodiments of the present invention.

FIG. 7 is a flow diagram illustrating an exemplary embodiment of a method mitigating contention cache side-channel attacks in accordance with one or more illustrative embodiments of the present invention.

FIG. 8 is a flow diagram illustrating pseudo-code an exemplary embodiment of the pointer update method mitigating contention cache side-channel attacks in accordance with one or more illustrative embodiments of the present invention.

FIG. 9A illustrates a state in a sequence of updates in a four-way set associative cache at an initial time in accordance with one or more illustrative embodiments of the present invention.

FIG. 9B illustrates a state in a sequence of updates in a four-way set associative cache occurring after a first time interval step in accordance with one or more illustrative embodiments of the present invention.

FIG. 9C illustrates a state in a sequence of updates in a four-way set associative cache occurring after a second time interval step in accordance with one or more illustrative embodiments of the present in accordance with one or more illustrative embodiments of the present invention.

FIG. 10A illustrating cache set allocation using the freelist when accessing an address set shown at an initial time in accordance with one or more illustrative embodiments of the present invention.

FIG. 10B illustrating cache set allocation using the freelist when accessing an address set shown after a first interval time step in accordance with one or more illustrative embodiments of the present invention.

FIG. 10C illustrating cache set allocation using the freelist when accessing an address set shown after a second time interval step in accordance with one or more illustrative embodiments of the present invention.

FIG. 11 shows a sample plot of a simulation shown the mapping of address sets to cache lines for an exemplary embodiment of a method of cache set allocation for contention cache side-channel defense in accordance with one or more illustrative embodiments of the present invention.

FIG. 12 shows a sample plot of a simulation shown the mapping of address sets to cache lines between cache lines 1625 and 1645 for an exemplary embodiment of a method of cache set allocation for cache side-channel defense in accordance with one or more illustrative embodiments of the present invention.

### DETAILED DESCRIPTION

A cache is a compact, fast-performing memory and, in a typical architectural application, stores information in a hierarchy of levels, often denoted sequentially as L1, L2, and continuing. A cache is further organized into cache blocks (equivalently, cache lines) which is the basic unit for storage. A cache set (equivalently, cache row) is a collection of cache lines, the number being determined by the layout of the cache which can be direct-mapped, set-associative or fully associative. A tag is a unique identifier for a group of data. It is convenient that a location in the cache may be referred to by its address in the cache or a pointer (an object that contains the address of a location), concepts that are familiar to one skilled in the art of computer architecture, memory and cache design, development and implementation.

When a cache is accessed, it is done so one cache line at a time. Each cache line possesses a tag that includes the location where data is stored in the cache. When data is requested from a cache, a search occurs through the tags to determine if the requested content resides in the hierarchy of cache levels. A cache hit occurs when a cache request can be successfully served from a cache. A cache miss occurs when the cache is searched, but the data cannot be found.

One cache or a hierarchy of caches bridge the gap between the speed of operation of processor or central processing unit (CPU) and memory access latency, by storing a copy of data that is likely to be accessed by the CPU. The location of data in the cache is conventionally determined by its memory address (whether physical or virtual), with the simplest approach using index bits created by splitting the address into tag, index, and offset bits. More sophisticated approaches, for example, modern Intel processors, may use a hash function to map addresses to different slices of a last-level cache (LLC). The combination of slice identification (ID) and index bits from the address are then used to determine the cache set in which the data can be cached, resulting in a many-to-one mapping of addresses to a cache set.

There are two broad categories of cache side channels (approaches to attack or discern information about the cache), depending on the presence of shared memory (shared code or data) between the attacker and the victim. The two types of attacks are called reuse-based and contention-based (equivalently, “contention”, or “contention side-channel”, or “contention cache side-channel”) attacks. In the presence of shared memory, an attacker may be able to determine the address of access by a victim at a cache line size precision using a reuse-based attack. In the absence of shared memory, the attacker can only determine the cache set accessed by the victim using contention-based attacks. Contention cache side-channel attacks exploit the static many-to-one mapping between a memory address and a cache set. Typically, this many-to-one mapping is fixed and, when known by an attacker, allows locating data in the cache quickly by the attacker. An attacker has the ability to learn the mapping over time by creating a set of addresses that evict each other from the cache. The present disclosure addresses defense against contention cache side-channel attacks, in particular.

An eviction set is defined as the group of addresses that when accessed, can replace the contents of a cache set. In a conventional cache, addresses with the same index bits and slice ID are said to be self-associative or congruent. This set of self-associative addresses can be used to form eviction sets that can replace the contents in the cache set. The notion of an eviction set is important for contention-based attacks because a subsequent slow access on one of the addresses in the eviction set implies that something else from the set of self-associative addresses was accessed. Thus, the concept of eviction sets is important for contention-based attacks because it provides the attacker with a set of possible addresses to guess that can result in access to the victim's data.

Some existing solutions for contention-based attacks use encryption to hide the actual address or the set of contending addresses in the cache. Side-channel contention defense using an encryption approach requires multiple cycles for encryption and decryption on every access. Since a static encrypted mapping can be reverse engineered given enough time, a new mapping is used every so often and the existing data in the cache is moved around. Relocating existing data in cache is extra work that can result in higher variance in application response time as well as potentially additional misuses. Other approaches resort to domain specific encryption or indexing, which might not support every use case in different computing domains. Designs that use encryption to hide eviction sets are still susceptible to eviction set discovery over time.

The inventors have discovered an approach to the defense against contention side-channel cache attacks based on randomization of the placement of data in a cache utilizing the run-time dynamics of the system and address indirection using software and/or hardware pointers (also referred to as “RollingCache” for convenience and brevity in the present disclosure) that does not require additional remapping using cryptography. Importantly, RollingCache defends against contention side-channel cache attacks even if the attacker is aware of the caching scheme, since predicting or detecting the cache behavior is not feasible due to the dependence of the caching behavior on the run-time state of the system. Moreover, RollingCache is not restricted to cache systems only, but can be utilized for implementing protection against contention attacks in other set associative structures, like translation lookaside buffers (TLBs). The RollingCache approach provides a defense mechanism that renders eviction sets less informative by changing them constantly.

In the RollingCache approach, not only is the set of conflicting addresses unknown, pointers to these addresses are also updated dynamically, making the discovery of the eviction set difficult. The rate at which the set of conflicting addresses is updated is directly related to the miss rate in the conflicting address sets. This prevents an attacker from discovering the set of conflicting addresses, as the accesses for discovering the eviction set update the set of addresses that contend in cache. The addresses that can contend with each other are a function of the runtime state of the cache.

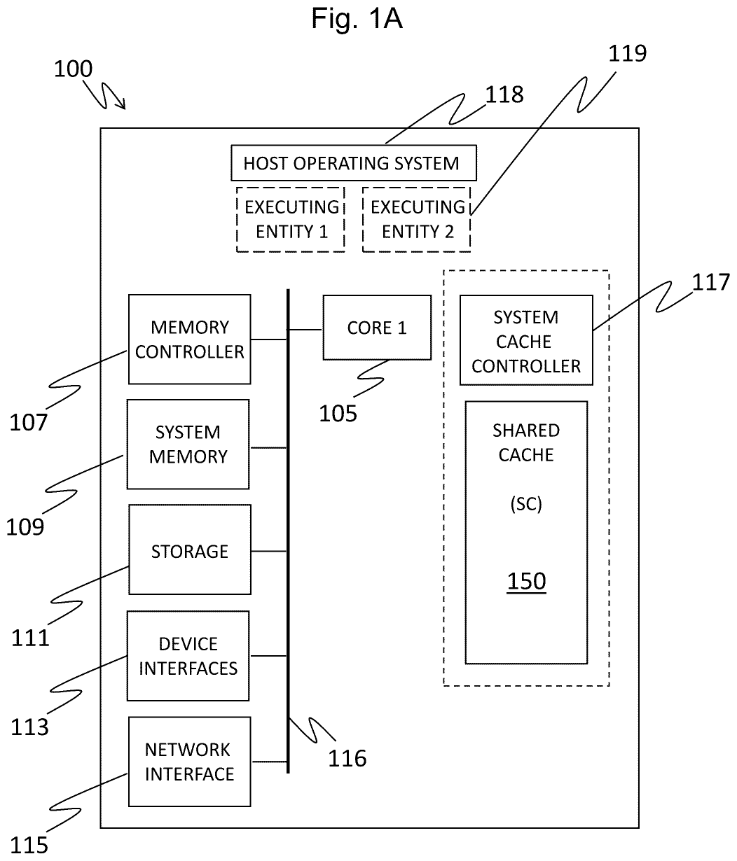

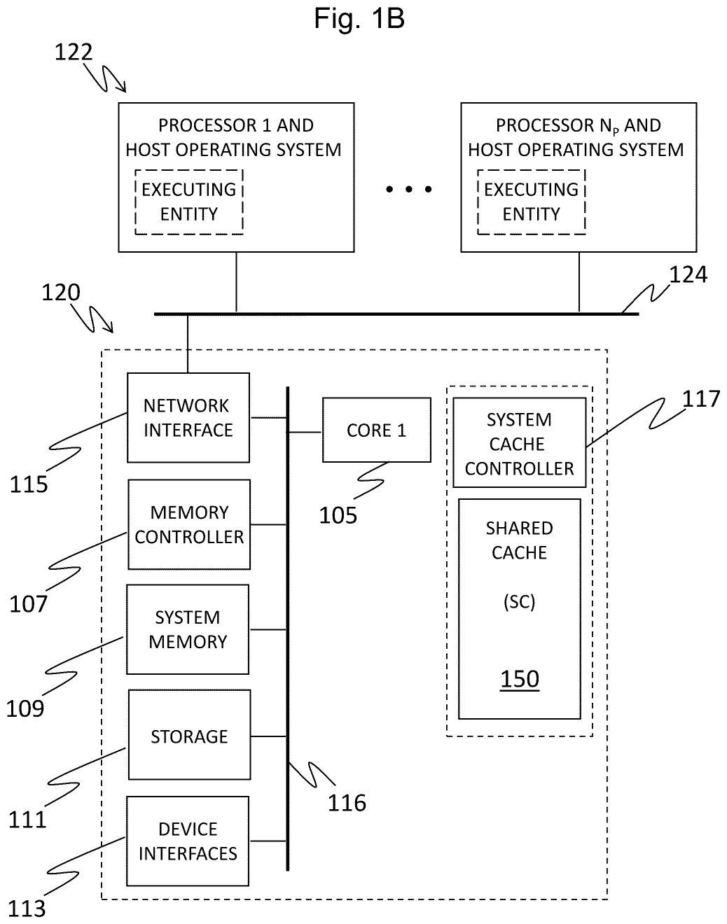

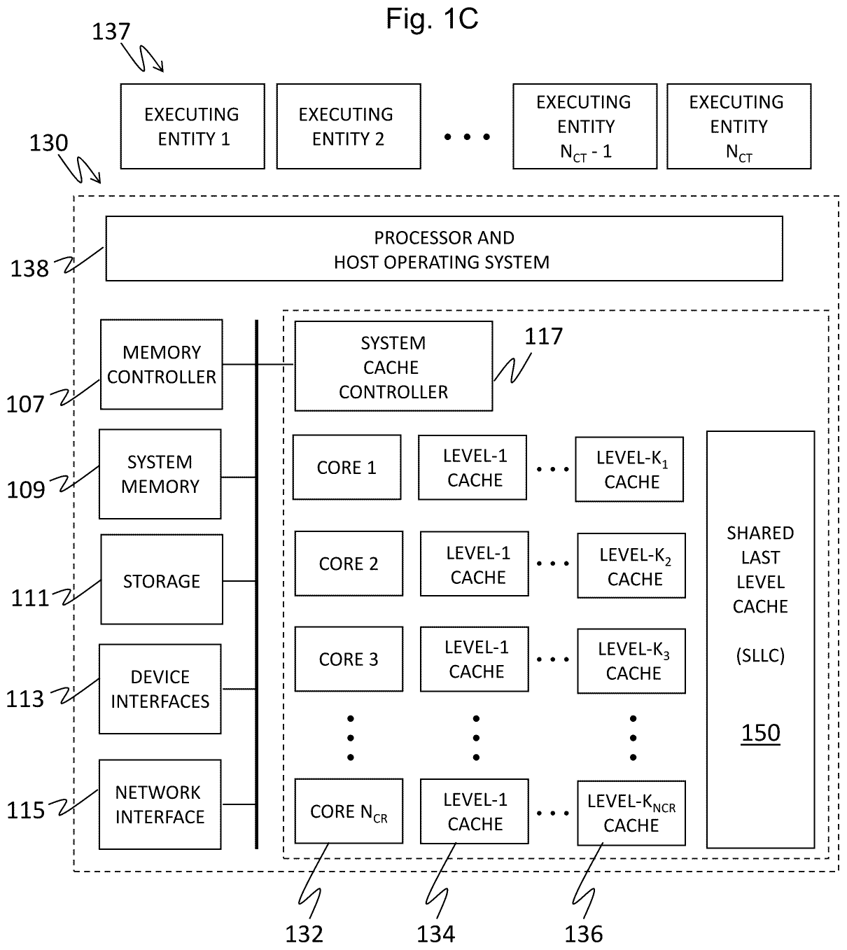

RollingCache defense against contention side-channel cache attacks applies to a wide spectrum of architectures with the common feature that they possess a cache; the disclosure is not to be interpreted as restricted to a specific computing domain or configuration. FIG. 1 provides an exemplary architecture configuration where RollingCache may be applied comprising of a computing system 100 including a single core 105 in communication with a memory controller 107, a system memory 109, an information storage subsystem 111, computing device interfaces 113 and a network interface 115, typically (but not restricted to) communication through an electrical bus 116. The computing processor core 105 is also serviced by a system cache controller (equivalently, a cache controller) 117 and a shared cache 150 organized as a collection of cache sets. The computing system further comprises a host operating system 118. Each of the components comprising the computing system 100 may comprise hardware, software and a combination of both hardware and software. Without being bound or limited by theory, the computing system 100 executes one or a plurality of executing entities 119 which may be processes, programs, instructions, circuits, devices or other architecture entities or elements capable of utilizing some or all of the resources of the computing system 100.

FIG. 1B provides another exemplary architecture configuration where RollingCache may be applied comprising of a computing system 120 such as a network accessible storage (NAS) device, including a single core 105 in communication with a memory controller 107, a system memory 109, an information storage subsystem 111, computing device interfaces 113 and a network interface 115, typically (but not restricted to) communication through an electrical bus 116. The computing processor core 105 is also serviced by a system cache controller (equivalently, a cache controller) 117 and a shared cache 150 organized as a collection of cache sets. In the exemplary configuration, one or a plurality of computing systems 122 that may comprise processors and host operating systems and are in communication with the computing system 120 with a shared cache 150 and system cache controller 117 using a network 124.

FIG. 1C provides another exemplary architecture configuration where RollingCache may be applied comprising of a computing system 130 including one or a plurality of cores 132 in communication with a memory controller 107, a system memory 109, an information storage subsystem 111, computing device interfaces 113 and a network interface 115, typically (but not restricted to) communication through an electrical bus 116. Each core is serviced by one or a plurality of exclusive caches 134 sequenced Level-1 (equivalently, L1), Level-2 (equivalently, L2) to Level-K_{NCR}, where K_{NCR} is the number of exclusive caches servicing core NCR. The computing system 130 is also serviced by a system cache controller (equivalently, a cache controller) 117 and a shared cache 150 (equivalently, a shared last level cache) organized as a collection of cache sets. The computing system may further comprise a processor and host operating system 138. Each of the components comprising the computing system 130 may comprise hardware, software and a combination of both hardware and software. Without being bound or limited by theory, the one or a plurality of executing entities 137, which may be processes, programs, instructions, circuits, devices or other architecture entities or elements, in communication with the computing system 130 utilize some or all of the resources of the computing system 130, which may include shared last level cache 150 resources.

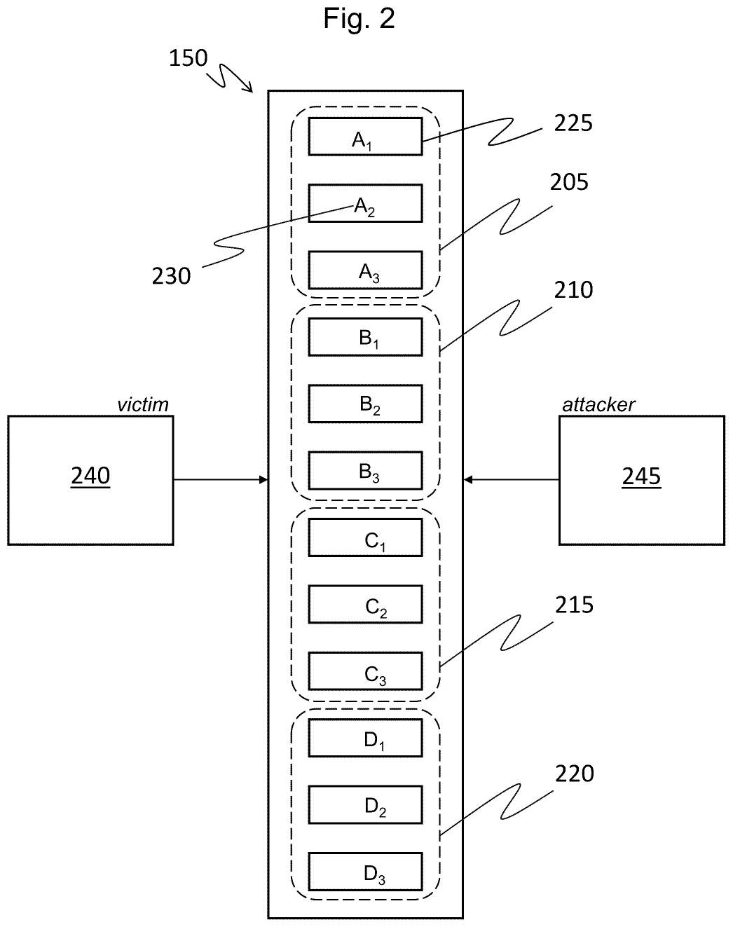

FIG. 2 presents the basic configuration for a contention side-channel cache attack. A shared cache 150 is illustrated showing four cache sets: Cache set A 205 comprises three cache lines 225 denoted A1, A2 (labeled 230) and A3. Cache sets B 210, cache set C 215 and cache set D 220 also comprise three cache lines each. Two execution entities, denoted the victim 240 and attacker 245, are serviced by the shared cache 150 through the system cache controller (not shown).

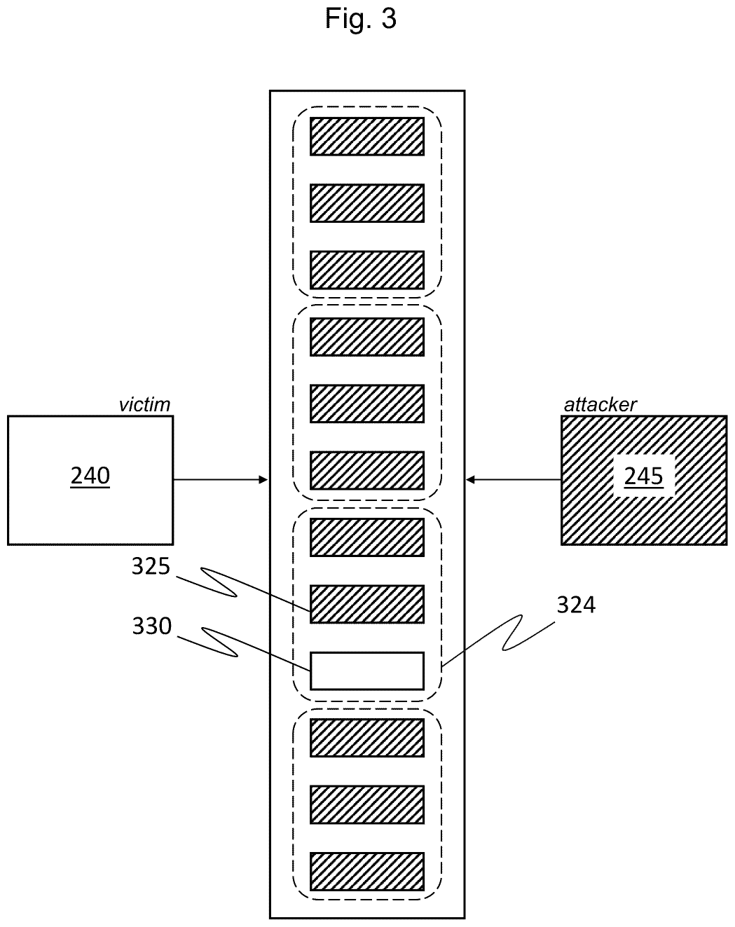

In a contention side-channel cache attacks, the attacker tries to determine the cache set accessed by the victim 240 as illustrated in FIG. 3. To carry out the attack, the attacker 245 needs the ability to time their own cache accesses. The attacker 245 allocates a memory congruent to the victim's memory and reads a value from every memory block in the contiguous memory location. They then wait for the victim's execution and access the previously accessed data for a second time. This iteration of accesses is timed.

The idea is to completely fill a cache set 324 with attacker's data, denoted by the collection of hatched cache lines 325, and allow the victim to cause partial eviction of the attacker's data to bring the victim's data 330 in the same set 324. If the victim 240 does access the same set, the attacker's 245 subsequent access to the set is delayed. Once the attacker 245 is aware of the cache set where a conflict occurred, the attacker 245 can guess the address using brute force trial and error, since the addresses that map to a cache set are already known.

In accordance with illustrative embodiments, dynamic contention side-channel cache defense includes gradually moving cache occupancy of a set of addresses from one cache set to another. Thus, the efforts involved in cryptographically segregating or moving around the content in the cache is avoided. Thus, the design of the cache is not hidden, yet the attacker cannot decipher the relation between the addresses and the cache locations.

A nomenclature is convenient for describing the RollingCache using dynamic, non-deterministic cache occupancy for contention side-channel cache attack defense. In the present disclosure, the terms AddrSet is identified as the set of addresses that get indexed into the same cache set in a conventional cache, and the term CacheSet is identified as the physical cache set location in the cache. There are as many AddrSets as there are CacheSets. A conventional cache has an AddrSet mapped to a single CacheSet. In accordance with one or more illustrative embodiments, RollingCache separates the AddrSet from the CacheSet and uses a level of indirection to map an AddrSet to two CacheSets at a time.

RollingCache provides dynamic mapping between AddrSets and CacheSets. A CacheSet can be filled by an address belonging to any AddrSet that points to it, and so an eviction may be the result of multiple AddrSets.

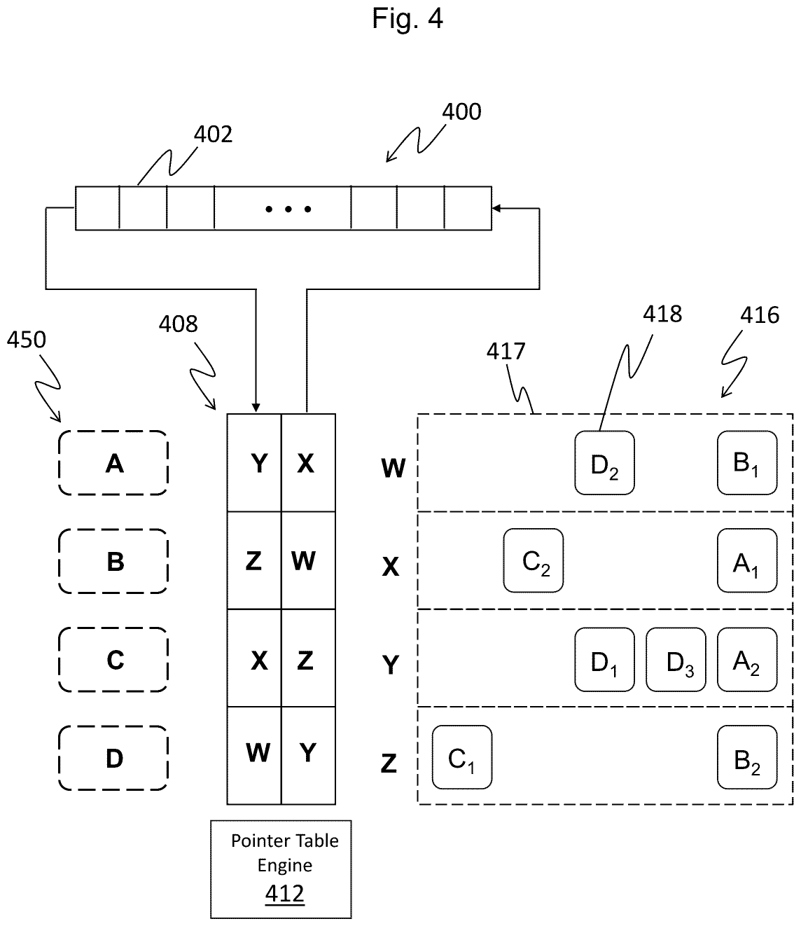

FIG. 4 illustrates the relationship between the indirection pointers and CacheSets, and how CacheSets may be occupied by multiple AddrSets. A collection of AddrSets 450 (denoted A, B, C and D for illustrative purposes) is mapped to a collection of CacheSets 416 (denoted W, X, Y and Z for illustrative purposes). The assignment of a particular AddrSet 418 (AddrSet D₂ for illustration) into a selected cache set 417 (the selected cache set W for illustration) is mapped by an indirection pointer table 408 through the action of a pointer table engine 412. A freelist 400 of pointers 402 to available cache lines is maintained for use by the pointer table engine 412 for the purposes of allocation of cache sets as described below.

Repeated cache fill requests from an AddrSet beyond a certain count, instead of causing eviction in the given CacheSet, rolls over to fill a different CacheSet. The data in the current filled CacheSet continues to be accessible while new cache fills occur in the newly assigned CacheSet. This newly assigned CacheSet is potentially already mapped to and filled or fillable by another AddrSet. This ability to contend with addresses that do not belong to the same AddrSet is useful for preventing contention-based attacks.

In certain illustrative embodiments, RollingCache finds a replacement victim CacheSet over all available CacheSets, rather than finding a replacement victim cache line within a cache set. The above scheme allows different AddrSets to have overlapping occupancy in a CacheSet resulting in contention with a dynamically changing set of AddrSets.

The mapping of an AddrSet to CacheSets is available in pointers referred to as the present-ptr (PrPtr) and the past-ptr (PsPtr), and an access proceeds by identifying the mapping for the AddrSet. The pointers may be initialized randomly at the time of system initialization, but other equivalent initialization schemes may be used. The index bits and the slice ID form the AddrSet that is used to look up the mapping for an access. Since data belonging to different AddrSets can reside in the same CacheSet, the AddrSet (the index bits in a conventional cache) is stored along with the tag bits to identify the cache lines, and a tag hit further needs AddrSet comparison to result in a cache hit. Both the CacheSets pointed at by the indirection pointers of an AddrSet may hold data for the AddrSet. A hit can be the result of data being found in either of the two CacheSets.

The difference between the PrPtr and the PsPtr is that cache fills occur only in the CacheSet pointed to by the PrPtr; that is, PrPtr[AddrSet], while data may be located in both PrPtr[AddrSet] and PsPtr[AddrSet]. In other words, the PrPtr[AddrSet] works as the active CacheSet for the AddrSet and the PsPtr[AddrSet] continues to be looked up for data that was placed in the past.

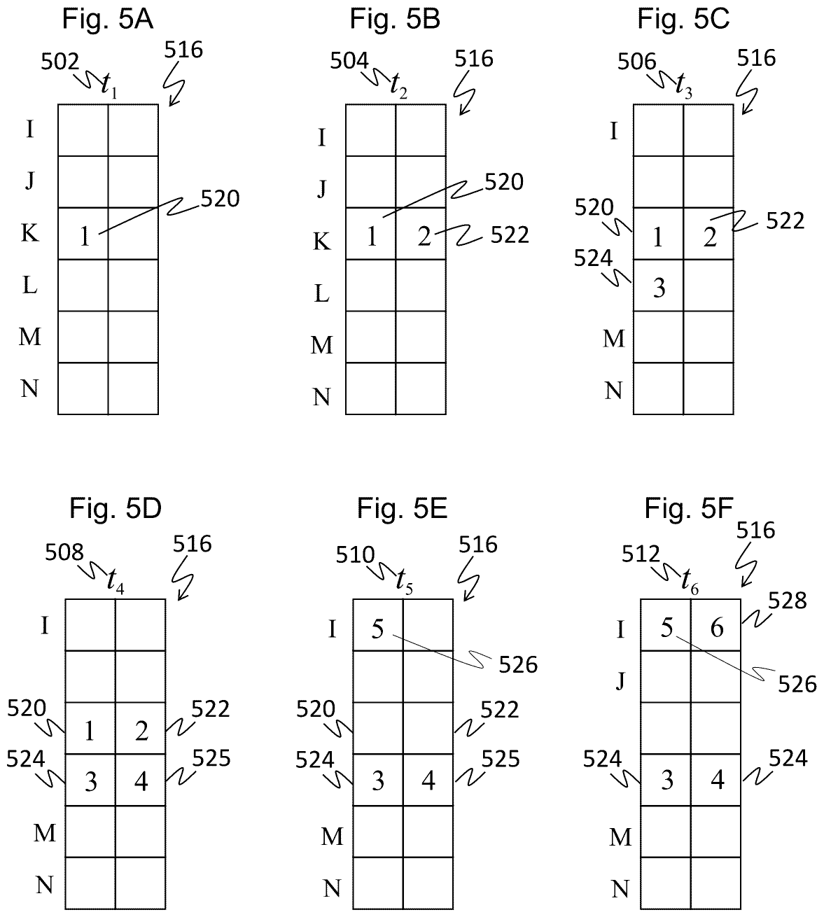

The cache access using an exemplative two-way cache 516 is illustrated in FIG. 5A through FIG. 5F. Referring to FIG. 5A the state of the two-way cache 516, at a time t₁ 502. The sequence shows the effect of repeated cache 516 accesses numbered one (1) through six (6) to some AddrSet A. FIG. 5A shows access one 520 to CacheSet K at a time t₁ 502. In FIG. 5B, accesses one 520 and two 522, are shown filled in CacheSet K at a time t₂ 504, because the PrPtr[A] has the value K. Subsequent access three 524 is displayed in FIG. 5C to is filled in CacheSet L at a time t₃ 506. Subsequent access four 524 is displayed in FIG. 5D to is also filled in CacheSet L at a time t₄ 508. Accesses three and four, instead of evicting one or two, fill CacheSet L, since the PsPtr[A] is updated to L. At this instant, the PsPtr holds K, and an access to one and two continues to hit in the cache, as the PsPtr[A] supports lookup. Further accesses fill CacheSet I and so on, as illustrated in FIG. 5E where access five 526 fills CacheSet I at a time t₅ 510. In FIG. 5F, the sixth 528 access to AddrSet A is mapped to CacheSet I at a time to 512.

The dynamic nature of this mapping comes from the fact that after a certain number of replacements, the PrPtr is updated to fill a different CacheSet and the PsPtr holds the previous PrPtr to allow visibility of the recently placed data.

The updating of the indirection pointer table by the pointer table engine is key to maintaining the dynamic non-deterministic properties of the RollingCache contention side-channel cache defense. A cache lookup results in a hit if the stored AddrSet bits in any of the cache lines in the cache sets PrPtr[AddrSet] and PsPtr[AddrSet] match the corresponding address bits of the cache access. Otherwise, a cache miss is incurred. A cache miss brings data into the active CacheSet, that is, PrPtr[AddrSet]. After a specific number of cache fills, a subsequent access resulting in a cache hit continues to be serviced, but a miss results in a pointer update-a miss finds a new CacheSet in which to replace a victim cache line. In illustrative embodiments, W cache fills from an AddrSet into its active CacheSet before the pointer updates to point to a new cache set. The count is associated with every AddrSet's PrPtr, and is reset at a pointer update. A cache fill in a given CacheSet takes place in one of the invalid cache lines. If there are no invalid cache lines available, a valid cache line in the CacheSet is picked as the replacement victim at random.

The current PsPtr is saved (in a PsPtr handling register) and replaced with the content of the PrPtr. A replacement victim CacheSet is picked to update the PrPtr. The replacement victim CacheSet is now the new active set, which gets filled with further accesses belonging to the AddrSet under consideration.

Cache lines corresponding to the AddrSet in the cache set pointed to by the saved PsPtr must be invalidated since the CacheSet is no longer accessible by the AddrSet after the pointer update. The cache lines to be invalidated are identified by comparing the AddrSet with the stored AddrSet bits in the tag for each cache line. The PsPtr handling register performs these invalidations and also handles any necessary writebacks. Since the time for these operations is not fixed and these operations are not atomic, misses in the cache due to accesses to a AddrSet must check the handling register. The cache can thereby continue to operate in a non-blocking fashion as long as the writeback buffers and handling registers do not overflow. Once the invalidations and writebacks are complete, the partially freed CacheSet is then put at the end of the freelist.

The sequence of operations for updating the indirection pointers are summarized as follows:

temp = PsPtr[AddrSet]
PsPtr[AddrSet] = PrPtr[AddrSet]
PrPtr[AddrSet] = replacement victim CacheSet
invalidate AddrSet cache lines in temp
freelist[tail] = temp

Pointer updates make it possible to have different AddrSets conflict in a CacheSet for the duration between pointer updates for the residing AddrSets. This implies both self and non-self associative addresses can conflict in a CacheSet (refer Section V-C).

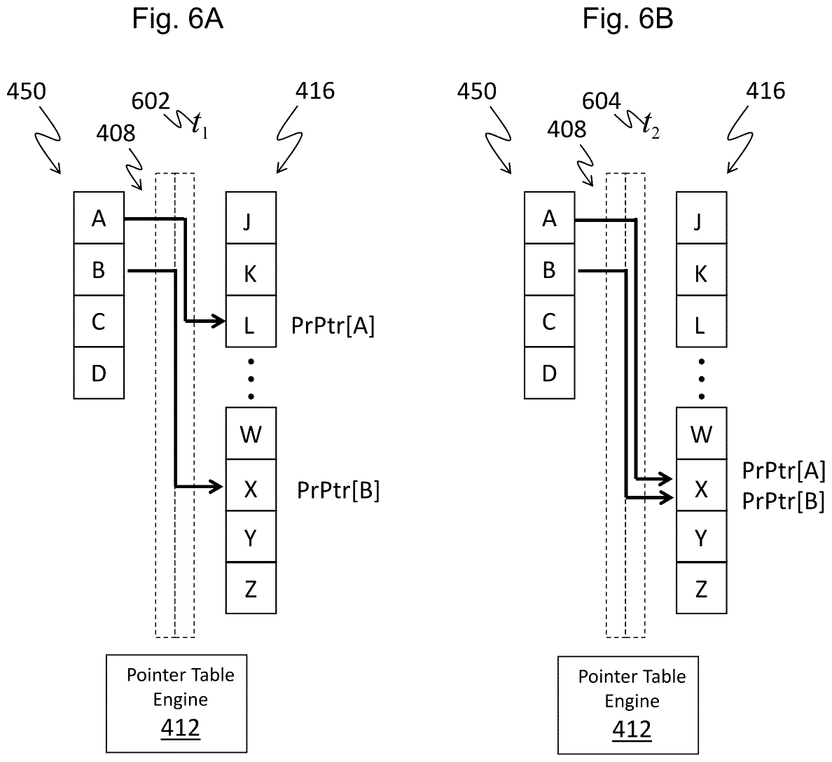

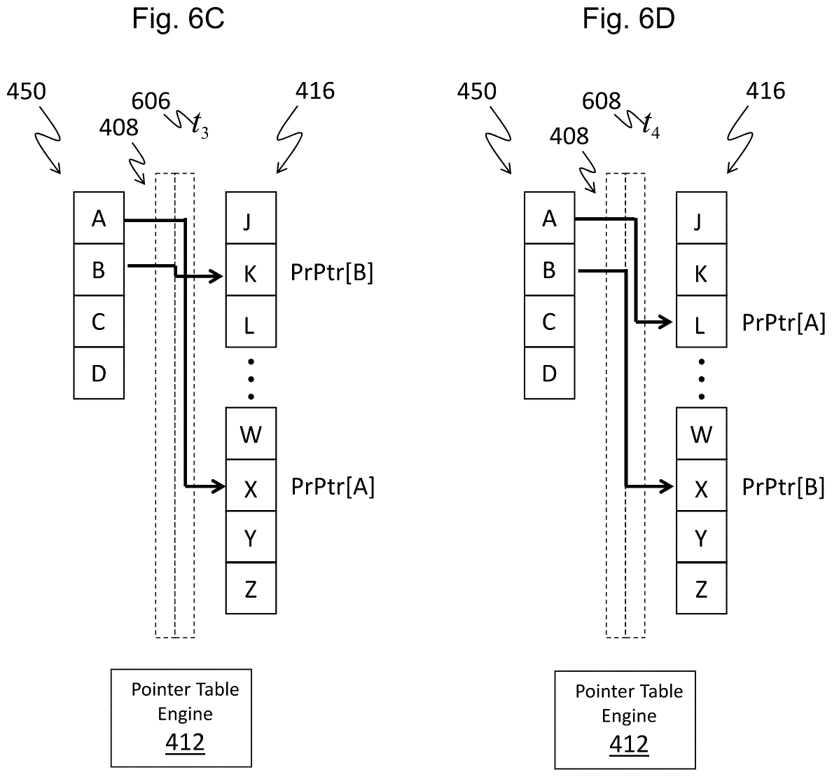

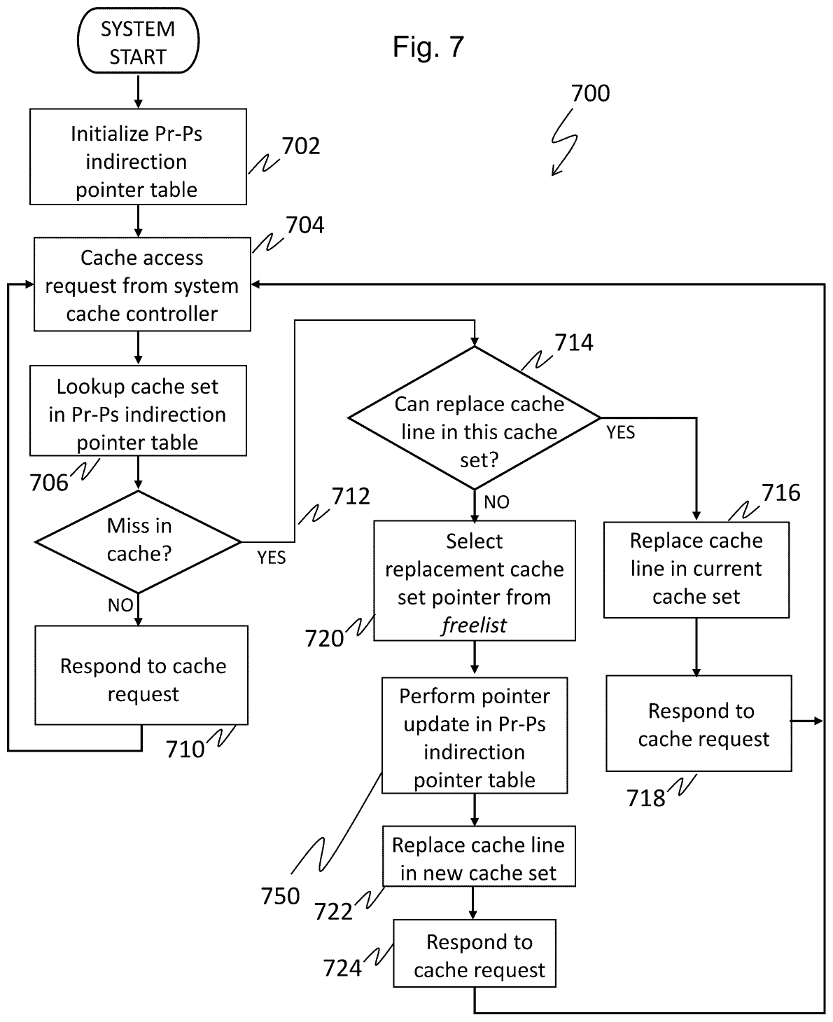

Referring to FIG. 6A through FIG. 6D, the drawings illustrate that pointer updates result contention across AddrSets. FIG. 6A displays the mapping of AddrSet 450 to the CacheSet 416 using the pointer indirection table 408 under the action of the pointer table engine 412. Referring to FIG. 6A, AddrSet A is mapped to CacheSet L (PrPtr[A]), and AddrSet B is mapped to CacheSet X (PrPtr[B]) at a time t₁ 602. In FIG. 6B, at time t₂ 604 when the pointer table engine 412 chooses to map AddrSet A to CacheSet X as the replacement victim, which already has content from AddrSet B, AddrSet A and AddrSet B can evict each other until either AddrSet A or B undergo a pointer update and loses the ability to fill CacheSet X. This creates cross contention between AddrSet A and AddrSet B, from time t₂ 604 to t₃ 606 and t₂ 604 to t₄ 608. FIG. 6C shows AddrSet A mapped to CacheSet X; that is, PrPtr[A] at time t₃ 606 while AddrSet B is mapped to CacheSet K (PrPtr[B]). Finally, in FIG. 6D, AddrSet A mapped to CacheSet L (PrPtr[A]) at time t₄ 608 while AddrSet B is mapped to CacheSet X (PrPtr[B]).

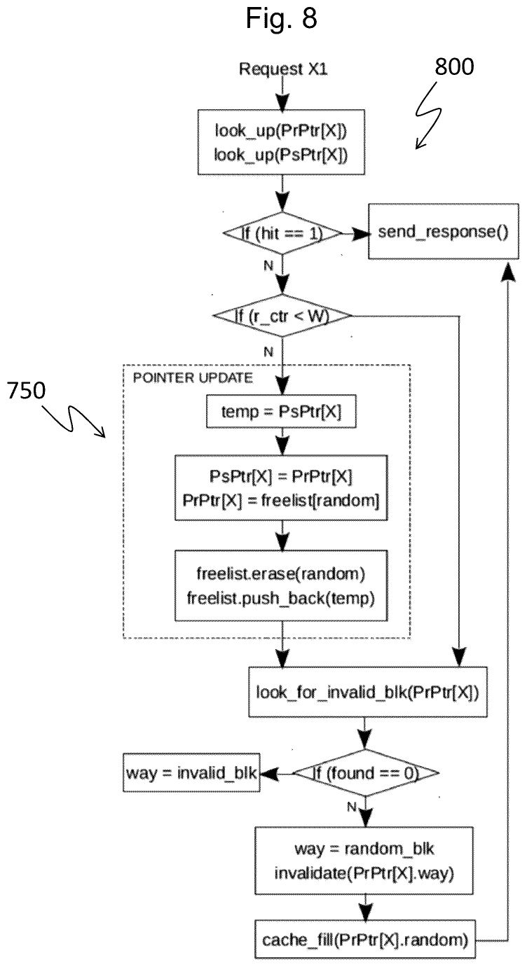

Referring to FIG. 8, a method flow diagram 700 for the initialization and management of an exemplary embodiment for a RollingCache system for defense against contention side-channel cache attacks is shown. After initialization of the indirection pointer table by the pointer table engine 702, when a cache access request is received from the system cache controller 704 the corresponding cache set is determined from the indirection pointer table 706. If a cache miss has not occurred, a response is transmitted to the system cache controller 710. If a cache miss has occurred 712, the pointer indirection table engine determines 714 if the requested cache line can be replaced. If the cache set allows the cache line to be replaced, the cache line is replaced in the current cache set 716 and a response is transmitted to the system cache controller 718. If the cache set does not allow the cache line to be replaced, a replacement cache set pointer is selected from the freelist 720, the indirection pointer engine updates the indirection pointer table 750, the cache line is replaced in the new cache set 722 and a response is transmitted to the system cache controller 724.

The replacement CacheSet victim for the pointer update is selected randomly from the freelist, a list of CacheSets that are highly likely to have invalid cache lines. The freelist updates on a pointer update; that is, an entry is removed from the list as the replacement victim, and the CacheSet being freed is added to the end of the list. The size of the freelist is a configurable design choice. The freelist is initialized randomly with different CacheSets at system startup.

Once a new CacheSet has been found, any invalid lines are filled before resorting to replacements. FIG. 8 illustrates one exemplative methodology 800 summarizing the mechanism of cache access, cache fill, and pointer updating in pseudocode using the nomenclature established in the present disclosure. TABLE 1 provides a description of the pseudocode terms used to describe the exemplary embodiment of the methodology in FIG. 8. The AddrSet under consideration here for cache accesses is denoted as ‘X’. An access is searched in both the present and the past CacheSets, and up to W cache fills are allowed before the next pointer update. The pointer update identifies a replacement victim CacheSet. Within the identified CacheSet, a random cache line is picked for replacement in the absence of invalid lines. The pointer update latency is not on the critical path and can be hidden behind the memory access latency, since it is performed only on a miss.

The random number used to index into the freelist can be generated from an on-chip hardware random number generator (HRNG) similar to PhantomCache. Intel CPUs can generate random numbers at 3 Gbps, which can support 500 million random indices for a freelist with 64 entries, for instance.

TABLE 1

| Term | Description |
|---|---|
| PsPtr[ ] | past CacheSet location |
| PrPtr[ ] | present CacheSet location |
| X | A CacheSet |
| hit | Denotes whether a request corresponds to a cache |
| | hit (TRUE) or cache miss (FALSE) |
| r_ctr | Replacement counter |
| W | The number of ways where a “way” is a degree of |
| | cache associativity |
| temp | A temporary location for storing a pointer |
| | contents |
| freelist[ ] | A structure to hold a list of available cache set |
| | locations |
| invalid_blk | cache line deemed to be invalid |
| random_blk | cache line selected at random |
| found | Denotes whether an invalid cache line has been |
| | found in a cache set |
| look_up( ) | Used to determine if the data is available in |
| | cache (FALSE if a miss) |
| send_response( ) | Used to transmit a response to a cache request to |
| | the system cache controller |
| freelist.erase( ) | Used to erase a freelist entry |
| freelist.push_back( ) | Used to add an entry to the freelist |
| look_for_in- | Used to look for an invalid cache line in a cache |
| valid_blk( ) | set |
| invalidate( ) | Used to invalidate a cache line |
| cache_fill( ) | Used to add content to a cache line |

Launching contention-based attacks requires identifying the AddrSets of interest and creating eviction sets for those AddrSets. The state of the cache with mapping from AddrSets to CacheSets and number of misses prior to rollover for different AddrSets, also referred to as the metadata, is unknown to the attacker. There are three properties of RollingCache that make it robust against these attacks. Attackers attempting to prime the cache might not end up occupying the entirety of each CacheSet associated with an AddrSet, as a result of which the victim can go undetected. Second, the eviction sets do not remain constant, changing as a function of cache replacement, and so cannot be reused for an attack. Finally, an eviction can be caused by self and non-self associative addresses. Hence, there is no direct correlation between a conflict miss and the addresses evicted. Each of these design aspects is analyzed in detail hereinbelow, and show how learning an eviction set using known methods is both difficult and not useful for the attack.

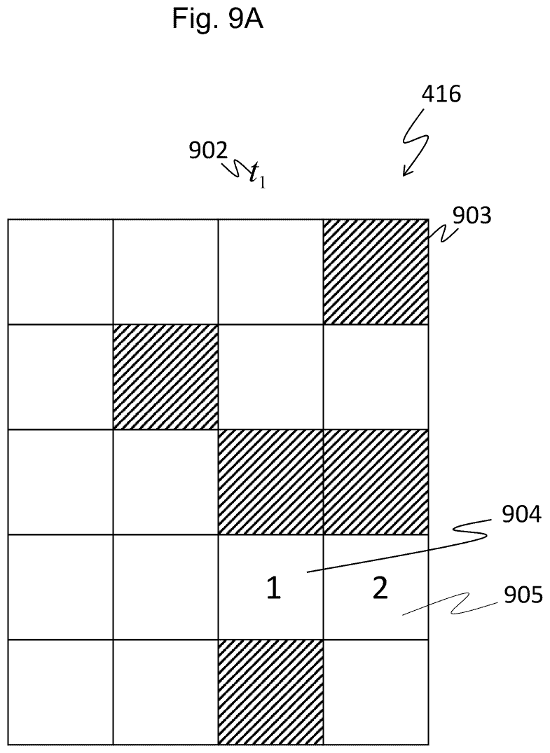

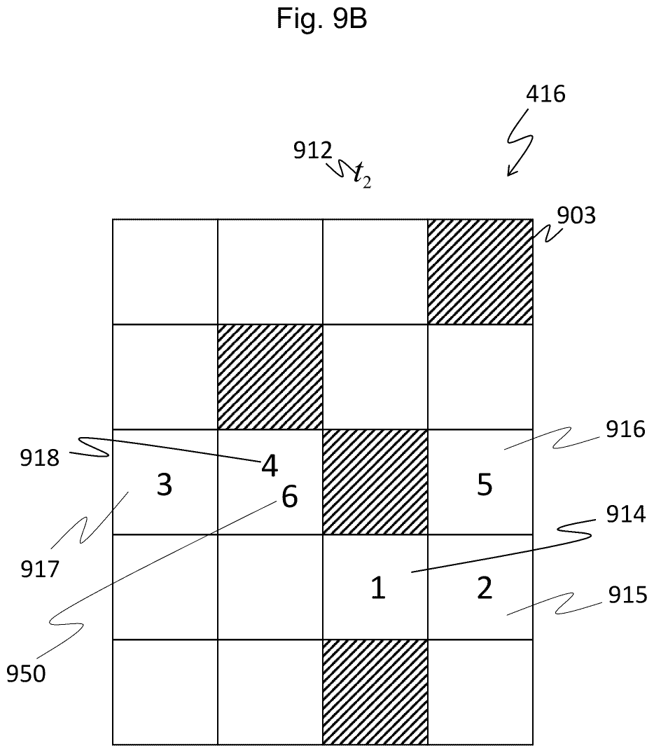

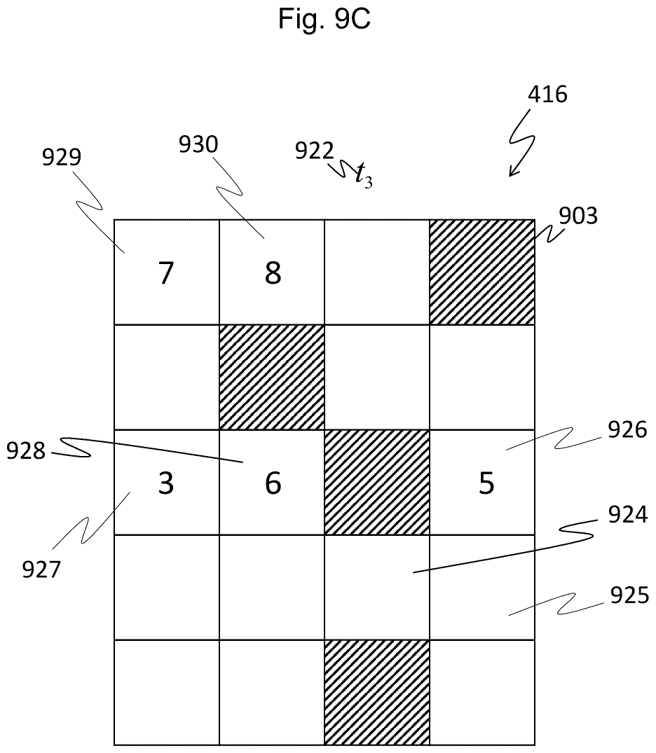

Unlike a conventional cache, where the eviction set size is W (where W is the number of ways), the number of unique cache line accesses that form an eviction set in RollingCache is not known. The attacker does not know how many accesses from an AddrSet remain before a pointer update, and therefore does not have the knowledge of how many accesses fill up the assigned CacheSets. Consider the following scenarios, with W and 2W accesses. Let the number of ways in the cache be four (W=4), and the AddrSet under consideration be ‘X’. FIG. 9A through FIG. 9C illustrate cache set 416 access at three sequential times.

First, consider accessing W elements: It is possible that AddrSet ‘X’ has been accessed two times before the attacker attempts to prime values from an AddrSet. The attacker's third access will result in a pointer update. The attacker's previous cache fills will be reachable as PsPtr[X], and the attacker incurs no misses. The victim is able to bring data into the cache without detection. For instance, after four accesses (the first corresponding to 704 in FIG. 9A; the second corresponding to 705 in FIG. 9A; the third corresponding to 717 in FIG. 9B; and the fourth corresponding to 718 in FIG. 9B) from the attacker as shown in, the victim's access fifth access 716 in FIG. 9B can go undetected, since all of the attacker's data is still accessible during attack probe.

Second, consider accessing 2W elements: If there are no invalid cache blocks in PrPtr[X], the attacker may evict its own cache lines at random, as shown by the sixth access 950 replacing the contents from the fourth access 918 in FIG. 9B. This is referred to as self-eviction during the prime stage. Secondly, a pointer update can occur midway, and result in a miss in an attacker's accesses even without the victim accessing AddrSet ‘X’, shown as access one and access two not being accessible after pointer two updates in FIG. 9C. Thus, the attacker does not know which entries can be expected to incur a hit during probe.

When the attacker probes the primed values, the misses from self-eviction, from having lost access to data due to two pointer updates, and from fills by another AddrSet, interfere with identifying the AddrSet accessed by the victim. Further, the misses due to the attacker's probe are likely to trigger another pointer update, losing the work done toward priming.

In a contention-based attack, the attacker, after determining an eviction set, accesses it to fill up a cache set, thereby replacing the victim's data. The eviction set is not constant in RollingCache. The addresses that conflict with each other in one CacheSet at any given instant may map to different CacheSets at another instant, and as soon as just after W misses. Thus, there is no replay possible with an eviction set. Discovering an eviction set is made futile by the fact that the attacker's prime and probe result in changing eviction sets.

In the final stage of the attack, the attacker relates the misses to one of the accesses in the eviction set. The evictions in RollingCache on an AddrSet are both due to self-associative and non-self-associative addresses. The self-associative evictions result from two consecutive pointer updates, or may be due to random cache line eviction, and can evict a maximum of W self-associative addresses. With only one PsPtr, the past pointer loses track of accesses beyond a single pointer update. However, both the CacheSets occupied through the two pointers have possible random evictions from non-self-associative accesses. The duration of the overlapping contention depends on the rate of access to the other AddrSets.

The eviction sets still exist and are of different sizes. However, there is no significance to the eviction set under the RollingCache design, i.e., a certain address being evicted does not imply a particular set of addresses might have been accessed by the victim. Thus, determining the set accessed by the victim upon contention is not possible anymore. Moreover, the probability of incurring a miss due to a self-associative address is lower than the probability of incurring a miss due to a non-self-associative address.

The freelist is a dynamic structure that allows rotation of CacheSets across different AddrSets. Its entries are as dynamic as the AddrSets that are accessed and undergo pointer update. The length of the freelist cannot be manipulated by the attacker, as every change to the freelist removes an entry and puts an entry on the list, resulting in no net effect on the list length. This means that the attacker cannot reduce the length of the freelist to make its behavior deterministic. Further, the entries on the freelist are a microarchitectural state not visible to the attacker; that is, they change at pointer update at instants unknown to the attacker. The attacker is not in control of which entries can be put on the freelist and at which time since it depends on the prior metadata.

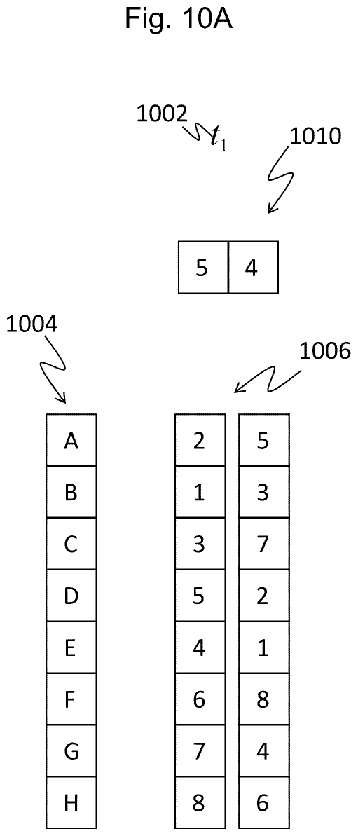

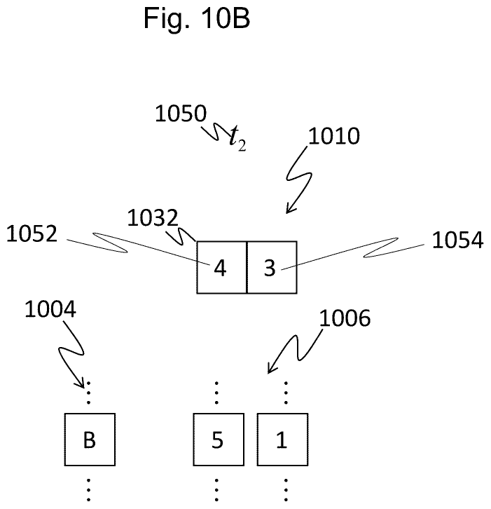

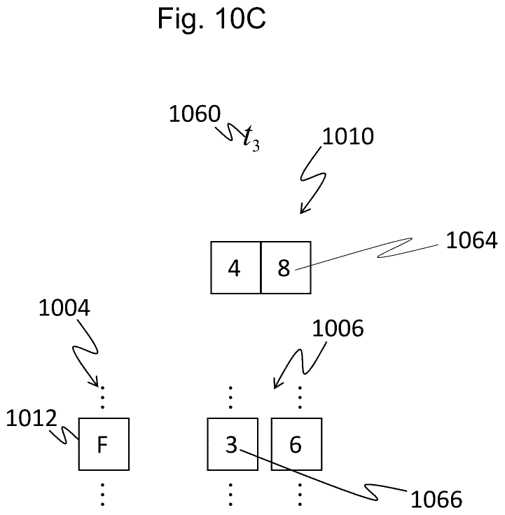

An attacker attempting to access a specific AddrSet constantly will cause the data from that AddrSet to roll over to CacheSets that may be picked from the freelist on pointer updates. A subsequent access by the victim to any of the other AddrSets that were potentially mapped to any of these CacheSets prior to the attacker's accesses, may result in a miss. Since these potentially contending AddrSets are not known to the attacker, they are unable to disambiguate among the AddrSets accessed by the victim. FIG. 10A through FIG. 10C shows a cache with eight CacheSets and a freelist of length two and can be used to illustrate how a sequence of different pointer updates to demonstrate the effect on an attack. In FIG. 10, A through H denotes AddrSets in the AddrSet collection 1004, with the mapping pointers indicated alongside the AddrSets in the indirection pointer table 1006, with the freelist entries listed at the top of each scenario 1010.

FIG. 10A through FIG. 10C illustrates how accessing a specific AddrSet allows CacheSets to rotate through the freelist without changing the existing mapping of other AddrSets to the same CacheSets. Moreover the sequence shows:

First, random initialization for the mappings and the freelist 1010 in FIG. 10A for a time t₁ 1002. Accesses occur from different AddrSets in the collection of AddrSets 1004 and their mapping in the pointer indirection table 1006 undergoes an update after W (numbers of ways) cache fills.

Second, FIG. 10B shows the instant at which AddrSet B 1012 undergoes a pointer update for a time t₂ 1050, the CacheSet labeled five 1056 is picked as the replacement victim, and the pointer labeled three 1054 is added to the freelist 1010;

Third, FIG. 10C shows that subsequently for a time t₃ 1060, the AddrSet F 1012 undergoes a pointer update, picks CacheSet three 1066, and puts eight 1064 back on the freelist 1010;

If the attacker has exclusive access over the cache and is interested in AddrSet F, it makes several accesses to AddrSet F, effectively moving data between CacheSets three, six, four and eight with any two of these CacheSets being accessible at any time.

Then, a subsequent delayed access after a victim's access could be due to contention from AddrSet C, E, H, or F (in CacheSets three, four, eight or six). While the state shown in FIG. 10C infers this sequence of events given the mappings, the attacker has no knowledge of the microarchitectural state of the cache. Thus, the attacker cannot know the smaller set of potentially conflicting AddrSets at time t₃ 1060 since the details cannot be derived due to the non-determinacy, indirection and dynamics of the RollingCache defense.

Thus, the attacker's repetitive accesses to the same AddrSet does not change the existing mapping of other AddrSets. Subsequent conflict misses from the other AddrSets mapping to the same CacheSets interfere with the attack.

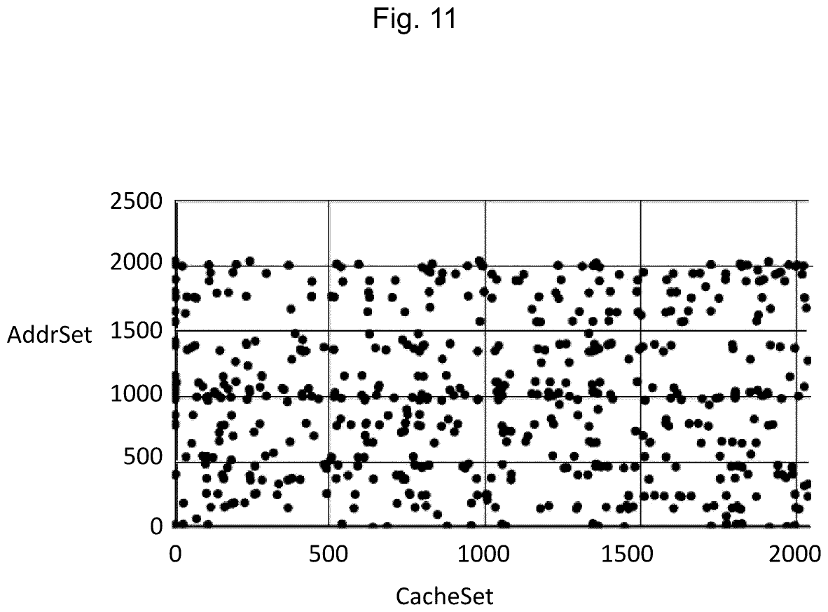

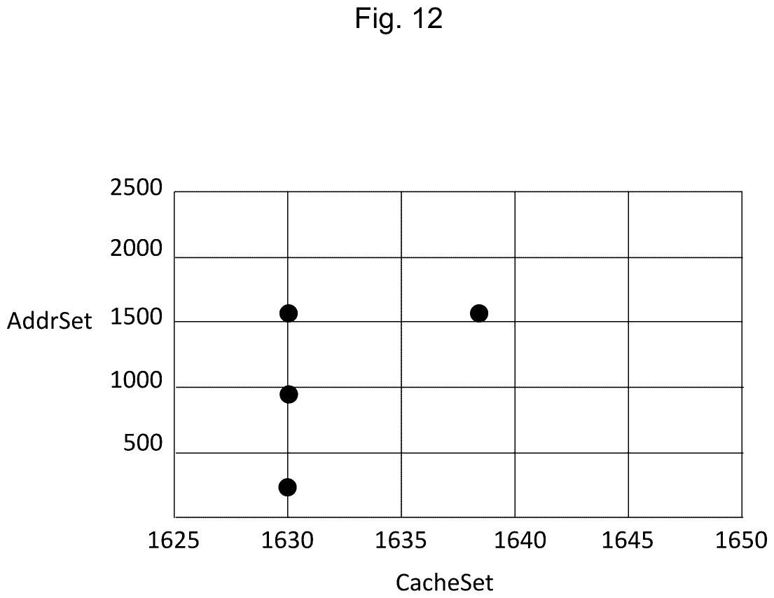

FIG. 11 shows the mapping of different AddrSets to CacheSets using the PrPtr, over 1000 LLC accesses in a sample application (pop2), run with 10 million warmup instructions. The dots represent the different AddrSets on the y-axis that occupy the CacheSets on the x-axis. The size of the LLC is 2 MB, and it has 2048 CacheSets. The scatter plot demonstrates how accesses to an AddrSet are spread across different CacheSets. FIG. 12 shows a fewer AddrSets and their active CacheSets. A closer look into the snapshot shows that a single CacheSet 1630 is the active CacheSet for 3 different AddrSets within the 1000 accesses window.

Details of the RollingCache performance analysis are provided in U.S. Provisional Patent Application Ser. No. 63/442,778 filed on Feb. 2, 2023, which is hereby incorporated by reference in its entirety including attachments and appendices provided therein.

Illustrative embodiments of the system and methodology of the exemplative RollingCache defense against contention side-channel cache attacks are provided in the present disclosure. The defense provides dynamic contention over different address sets rather than hiding eviction sets through encryption. In illustrative embodiments, the system and methodology decouples address sets from cache sets, and uses indirection to point accesses from address sets to cache sets. Address sets are allowed a specified number of fills to a cache set, beyond which the mapping is updated, and the address set continues to fill a different cache set. The system and methodology does not require data relocation on a pointer update and enables cache lookup in the cache set filled previously. The dynamically updating indirection pointers allow contention between different address sets at different instances of time.

The present invention is not to be limited in scope by the specific embodiments described herein. Indeed, various modifications of the invention in addition to those described herein will become apparent to those skilled in the art from the foregoing description. Such modifications are intended to fall within the scope of the appended claims.

While embodiments of the present disclosure have been particularly shown and described with reference to certain examples and features, it will be understood by one skilled in the art that various changes in detail may be effected therein without departing from the spirit and scope of the present disclosure as defined by claims that can be supported by the written description and drawings. Further, where exemplary embodiments are described with reference to a certain number of elements it will be understood that the exemplary embodiments can be practiced utilizing either less than or more than the certain number of elements.

All references cited herein are incorporated herein by reference in their entirety and for all purposes to the same extent as if each individual publication, patent or patent application was specifically and individually indicated to be incorporated by reference in its entirety for all purposes.

The citation of any publication is for its disclosure prior to the filing date and should not be construed as an admission that the present invention is not entitled to antedate such publication by virtue of prior invention.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specifications and/or claims, are to be construed as permitting both direct and indirect (i.e. via other elements or components) connection. In addition, the terms “a” or “an”, as used in the specifications and/or claims, are to be construed as meaning “at least one of.” Finally, for ease of use, the terms “including” and “having” (and their derivatives), as used in the specification and/or claims, are interchangeable with and have the same meaning as the word “comprising.”

It will be appreciated that variants of the above-disclosed and other features and functions, or alternatives thereof, may be combined into many other different systems or applications. Various presently unforeseen or unanticipated alternatives, modifications, variations, or improvements therein may be subsequently made by those skilled in the art which are also intended to be encompassed by the following claims.

The disclosed system can alternately comprise, consist of, or consist essentially of, any appropriate components herein disclosed. The disclosed system can additionally be substantially free of any components or materials used in the prior art that are not necessary to the achievement of the function and/or objectives of the present disclosure.

The terms “a” and “an” do not denote a limitation of quantity, but rather denote the presence of at least one of the referenced item. The term “or” means “and/or” unless clearly indicated otherwise by context. Reference throughout the specification to “an embodiment”, “another embodiment”, “some embodiments”, and so forth, means that a particular element (e.g., feature, structure, step, or characteristic) described in connection with the embodiment is included in at least one embodiment described herein, and may or may not be present in other embodiments. In addition, it is to be understood that the described elements may be combined in any suitable manner in the various embodiments. “Optional” or “optionally” means that the subsequently described event or circumstance may or may not occur, and that the description includes instances where the event occurs and instances where it does not. The terms “first,” “second,” and the like, “primary,” “secondary,” and the like, as used herein do not denote any order, quantity, or importance, but rather are used to distinguish one element from another. The terms “front”, “back”, “bottom”, and/or “top” are used herein, unless otherwise noted, merely for convenience of description, and are not limited to any one position or spatial orientation.

The endpoints of all ranges directed to the same component or property are inclusive of the endpoints, are independently combinable, and include all intermediate points. For example, ranges of “up to 25 N/m, or more specifically 5 to 20 N/m” are inclusive of the endpoints and all intermediate values of the ranges of “5 to 25 N/m,” such as 10 to 23 N/m.

Unless defined otherwise, technical, and scientific terms used herein have the same meaning as is commonly understood by one of skill in the art to which this invention belongs.

What is claimed is:

1. A system for defending against contention side-channel cache attacks, comprising:
one or a plurality of processors;
at least one cache in communication with at least one of said processors;
a system cache controller;
an indirection pointer table that assigns addresses to one or more cache sets;
a freelist of pointers corresponding to available cache sets; and
a pointer table engine for updating said indirection pointer table using said freelist of pointers and pointer indirection.

2. The system of claim 1, wherein the indirection pointer table is further comprised of hardware pointers.

3. The system of claim 1, wherein the freelist is comprised of hardware pointers.

4. The system of claim 1, wherein the indirection pointer table and freelist comprises a microcode unit.

5. The system of claim 4, wherein the microcode unit further comprises said pointer table engine.

6. The system of claim 1, wherein the system cache controller further comprises said pointer table engine.

7. The system of claim 1, wherein said pointer table engine for updating said indirection pointer table uses one level of pointer indirection.

8. The system of claim 1, wherein said pointer table engine for updating said indirection pointer table uses at least one level of pointer indirection.

9. A processor in communication with at least one cache and a cache controller, comprising:
circuitry configured to:
receive an address,
assign said address to a cache set using an indirection pointer table that assigns addresses to one or more cache sets using on a freelist of pointers corresponding to available cache sets, and
update said indirection pointer table in the event of a cache miss by a pointer table engine using said freelist of available pointers and at least one level of pointer indirection.

10. The system of claim 9, wherein the circuitry comprises a microcode unit.

11. The system of claim 9, wherein the indirection pointer table is further comprised of hardware pointers.

12. The system of claim 9, wherein the freelist is comprised of hardware pointers.

13. The system of claim 9, wherein cache controller further comprises instructions that implement the pointer table engine.

14. The system of claim 9, wherein said pointer table engine for updating said indirection pointer table uses one level of pointer indirection.

15. The system of claim 9, wherein said pointer table engine for updating said indirection pointer table uses at least one level of pointer indirection.

16. A method for defending against contention side-channel cache attacks in a system including a processor having at least one cache and a system cache controller, the method comprising:
initializing a pointer table engine;
executing the pointer table engine to initialize the indirection pointer table and freelist;
responding to the receipt of a cache request from the system cache controller:
responding to the determination by the pointer table engine that the cache request does not correspond to a cache miss, execute cache request;
responding to the determination by the pointer table engine that the cache request does correspond to a cache miss:
replace pointer assignment in cache set associated with the existing pointer if replacement is available, and respond to the cache request based on pointer reassignment; otherwise,
responding to the determination that a replacement is not available, select a cache set from the freelist, update indirection pointer table, and respond to the cache request using updated indirection pointer table.

17. The method of claim 16, initializing said indirection pointer table further comprising randomly initializing the pointers of the indirection pointer table.

18. The method of claim 16, initializing said freelist further comprising randomly initializing the pointers of the freelist.

19. The system of claim 16, wherein said pointer table engine for updating said indirection pointer table uses at least one level of pointer indirection.
